(19) United States
(12) Patent Application Publication
(10) Pub. No.: US 2015/0114261 A1
(43) Pub. Date: Apr. 30, 2015

(54) HEAT RESISTANCE BIO-ADHESIVES

(71) Applicant: EMPIRE TECHNOLOGY DEVELOPMENT LLC, Wilmington, DE (US)

(72) Inventor: Arockiadoss THEVASAHAYAM, Madurai (IN)

(21) Appl. No.: 14/529,470

(22) Filed: Oct. 31, 2014

(30) Foreign Application Priority Data
Oct. 31, 2013 (IN) 4900/CHE/2013

(51) Int. Cl. C09J 4/00

(52) U.S. Cl. CPC C09J 4/00
USPC 106/287.23; 540/469

(57) ABSTRACT

An adhesive material produced by contacting a catechol with an amine may be stable under heated conditions and produce minimal outgassing under vacuum. The catechol may be an un-substituted catechol or a substituted catechol, such as hydroxychavicol. In some examples, the catechol may be derived from botanical sources. The amine may be a diamine, such as phenylene diamine. The adhesive polymer may form dendritic structures or macrocyclic structures. A joined article may be fabricated from two materials by applying the adhesive to a prepared surface of at least one of the materials, and the two materials may be placed together with the adhesive between them. The adhesive in the joined article may be cured at ambient temperature or under heating conditions.

### CLAIM OF PRIORITY

Under 35 U.S.C. §119(a), this application claims benefit of and priority to Indian Patent Application No. 4900/CHE/2013 entitled “Heat Resistant Bio-Adhesives” filed Oct. 31, 2013 the disclosure of which is incorporated by reference herein in its entirety.

### BACKGROUND

One common issue with adhesives in high-tech manufacturing industries is the outgassing characteristics of the adhesives and their encapsulation and sealing compounds. A number of high-tech industries have discovered product and process sensitivity to outgassed chemical compounds.

Adhesives demonstrating significant outgassing may include those that cure through the loss of solvents or moisture from the uncured material. Some examples of such adhesives may include pressure-sensitive and contact adhesives, as well as cyanoacrylates. Some adhesives may demonstrate low outgassing and high adhesive strength under ambient conditions, but may outgas significantly when subjected to more extreme conditions such as high temperature, vacuum, or both.

Heat resistance may also be a useful property for adhesives deployed under certain specific conditions. A heat resistant adhesive may be one that does not change its physical or adhesive characteristics within a range of temperatures. Heat resistance may be especially useful for conditions under which two distinct materials may be bonded together, each material having a different thermal coefficient of expansion. A heat resistant adhesive may have sufficient flexibility to maintain the bond between the two materials despite changes in the shape and size of one material with respect to the other as the two materials are heated. Examples of bonding materials having different coefficients of expansion may include, without limitation, ceramic to metal bonding, ceramic to CRFP (carbon-fiber reinforced polymer) bonding, bonding of two metals with different coefficients of expansion, and metal to CRFP bonding.

It is, therefore, useful to develop a low-out-gassing and heat-resistant adhesive that can maintain its properties at high temperature, under vacuum, or both. Such an adhesive may find use, for example, in semiconductor manufacturing processes where low outgassing is desired under vacuum and high temperature conditions.

### SUMMARY

In an embodiment, a method for making an adhesive, may include contacting at least one catechol with at least one amine to form a first mixture, adding at least one solvent to the first mixture to form a second mixture, and subjecting the second mixture to at least one reaction condition thereby forming the adhesive.

In an embodiment, an adhesive material may include a compound of Formula 1 in which n is an integer of 2 to about 25, each A is independently selected from an alkyl, an alkenyl, an alkynyl, or an aryl moiety, each R₁ is independently selected from an alkyl, an alkenyl, or an alkynyl moiety, each k is the number of substituent groups R₁ and is an integer from 0 (resulting in an unsubstituted catechol) to 4 (the maximum number of substituents of each catechol ring), each R₄ and each R₅ is independently selected from a hydrogen or a compound of Formula 2, in which m is an integer of 2 to about 25,and R₂ and R₃ are hydrogen, or joined together when n is greater than or equal to 2.

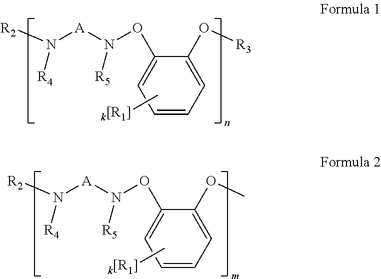

In another embodiment, an adhesive material may be composed of a reaction product of one or more catechol compounds and one or more amine compounds.

In another embodiment, a method of using an adhesive, may include contacting at least a prepared first surface of a first material with a first amount of an adhesive, and contacting a prepared second surface of a second material with the adhesive in contact with the prepared first surface of the first material, thereby forming a joined article, in which the adhesive material may include a reaction product of one or more catechol compounds and one or more amine compounds.

### BRIEF DESCRIPTION OF THE DRAWINGS

FIG. 1 is a flow chart of a method for making an adhesive in accordance with the present disclosure.

FIG. 2 is a flow chart of a method for using an adhesive in accordance with the present disclosure.

FIG. 3A is an embodiment of an experimental apparatus to test tensile stress and strain applied to an adhesive in accordance with the present disclosure.

FIG. 3B is an embodiment of an experimental apparatus to test shear stress and strain applied to an adhesive in accordance with the present disclosure.

FIG. 4 is an embodiment of an experimental apparatus to test tensile stress applied to an adhesive under conditions of heat and vacuum in accordance with the present disclosure.

### DETAILED DESCRIPTION

In some applications, low out-gassing adhesives may include those that meet U.S. National Aeronautics and Space Administration (NASA) requirements as described by ASTM Standard E595-07. Adhesives that pass the ASTM E595-07 standard may be used in space-worthy technologies. Adhesives meeting the standard may include those that lose less than 1% of their weight after 24 hours while heated to 125 degrees C. and under a vacuum of no greater than 6.7×10⁻⁶ kPa. Adhesives also meeting the standard may include those that lose more than 1% of their weight under the above conditions, but that regain less than 1% of their weight after being exposed for 24 hours to air having 50% relative humidity at ambient temperature. Alternative requirements for low outgassing may include adhesives that do not peel away from the adherent surfaces under high temperatures (such as, for example, 200 degrees C.) and vacuum for long periods of time, including, for example, over the course of a year or more.

Heat resistant adhesives may be those that maintain the strength of their bond between materials having dissimilar coefficients of expansion. Without being bound by theory, adhesives that lack heat resistance may be those that retain some residual tensile stress due to unequal thermal expansion of the adhering materials. After several thermal cycles, such residual stress may build up until the adhesive no longer bonds to one or both surfaces of the adhering materials.

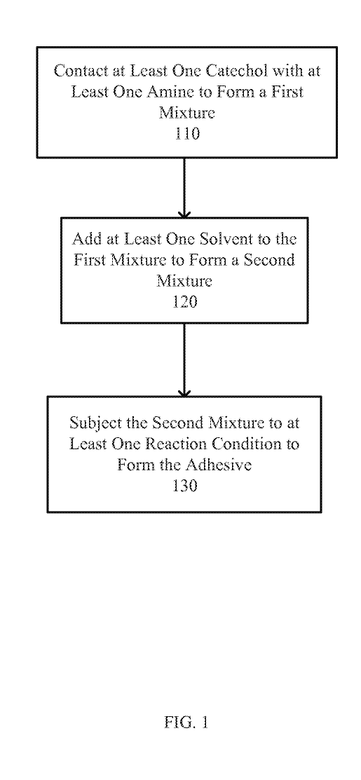

As disclosed in FIG. 1, an adhesive may be produced by contacting 110 at least one catechol with at least one amine to form a first mixture. At least one solvent may be added 120 to the first mixture to form a second mixture. The second mixture may then be subjected 130 to at least one reaction condition to form the adhesive. The adhesive may thus be a reaction product of one or more catechol compounds and one or more amine compounds.

A catechol has a generic structure as indicated by Structure 1, which may be substituted (n=0) or unsubstituted (n=1, 2, 3, or 4). When substituted, each R may be independently selected and attached to the benzene ring at the 3, 4, 5, and/or 6 carbons.

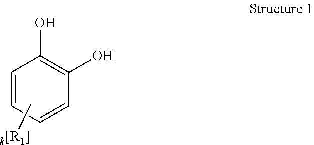

Catechol is a molecule of Structure 1 in which k is 0 (that is, R is H at all carbon positions 3, 4, 5, and 6 of the benzene ring). A mono-substituted catechol (k=1) has a single substituent R that is not H at one of the 3, 4, 5, or 6 benzene ring carbons. A poly-substituted catechol may have two to four substituents R at any of positions 3, 4, 5, and/or 6. Each of the substituents R₁ of a poly-substituted catechol may be independently chosen. For the purpose of this disclosure, the term catechol, unless otherwise defined, may refer to one or more of catechol, a mono-substituted catechol, or a poly-substituted catechol.

R₁ may be chosen from an alkyl, an alkenyl, or an alkynyl moiety. In a poly-substituted catechol, each R may be independently chosen from an alkyl, an alkenyl, or an alkynyl moiety. In some non-limiting embodiments, the alkyl, the alkenyl, or the alkynyl moiety may be a straight chain moiety. Without limitation, the alkyl moiety may have a primary carbon backbone having a length of about 1 carbon to about 25 carbons. The alkenyl, and the alkynyl moiety may have a primary carbon backbone having a length of 2 carbons to about 25 carbons. Non-limiting examples of alkyl moiety chain length may include about 1 carbon, about 5 carbons, about 10 carbons, about 15 carbons, about 20 carbons, about 25 carbons, or ranges between any two of these values (including endpoints). Non-limiting examples of alkenyl or alkynyl moiety chain length may include about 2 carbons, about 5 carbons, about 10 carbons, about 15 carbons, about 20 carbons, about 25 carbons, or ranges between any two of these values (including endpoints), and may include one or more double or triple bonds, respectively. In some non-limiting embodiments, the alkyl, the alkenyl, or the alkynyl moiety may be a branched-chain moiety. A branched-chain alkyl, alkenyl, or alkynyl moiety may have one or more carbon side-chains bonded to the primary carbon backbone. The carbon side-chains may be independently chosen to have from 1 to about 5 carbons. Non-limiting examples of alkyl, alkenyl, or alkynyl moiety side-chain length may include about 1 carbon, about 2 carbons, about 3 carbons about 4 carbons, or about 5 carbons. Each of the alkyl, alkenyl, or the alkynyl moieties may optionally be substituted with one or more substituent selected from C₁-C₅alkyl, C₂-C₅alkenyl, C₂-C₅alkynyl, C₁-C₅cycloalkyl, C₁-C₅cycloheteroalkyl, C₁-C₅heteroalkyl, C₂-C₅heteoralkenyl, C₂-C₅ heteroalkynyl, heteroaryl, and wherein each heteroalkyl, cycloheteroalkyl, heteoralkenyl, heteroalkynyl, heteroaryl contains one or more hetero atom selected from N, O, P, S, Cl, Br, and I.

In some non-limiting examples, the at least one catechol may be a 3-substituted catechol, a 4-substituted catechol, or a 3, 4-disubstituted catechol. In some non-limiting examples, the at least one catechol may be a 4-alkyl substituted catechol, a 4-alkene substituted catechol, a 4-alkyne substituted catechol, or a combination thereof. Examples of one or more catechols my include, without limitation, 4-methyl catechol, 4-ethyl catechol, 4-propyl catechol, 4-butyl catechol, 4-(ethenyl)catechol, 4-(2-propen-1-yl)catechol, 4-(3-buten-1-yl)catechol, 4-(ethynyl)catechol, 4-(2-propyn-1-yl)catechol, 4-(3-butyn-1-yl)catechol, or combinations thereof. It may be understood that 4-(2-propen-1-yl)catechol may also refer to 4-allylcatechol or hydroxychavicol.

An at least one amine may include a primary amine, a secondary amine, a tertiary amine, a diamine, or a combination thereof. In one non-limiting example, a tertiary amine may include nitrilotriacetic acid. In some non-limiting embodiments, the at least one amine is one or more of an alkylene diamine, an alkenylene diamine, an alkynylene diamine, or an aryl diamine. Some non-limiting examples of diamines may include methylene diamine, ethylene diamine, ethylene diamine tetraacetic acid, propylene diamine, butylene diamine, 1,2 phenylene diamine, 1,3 phenylene diamine, 1,4 phenylene diamine, 1,1′-diphenyl diamine, or a combination thereof.

Contacting 110 the at least one catechol with the at least one amine to form a first mixture may include combining an amount of the catechol with an amount of the amine. In one non-limiting example, a molar ratio of the catechol to the amine may be of about 2:1 to about 5:1. Non-limiting examples of the molar ratio of the catechol to the amine may be of about 2:1, 2.5:1, 3:1, 3.5:1, 4:1, 4.5:1, 5:1, or ranges between any two of these values (including endpoints). Non-limiting examples of combining the catechol with the amine may include stirring, mixing, blending, macerating, and/or grinding together.

Adding 120 at least one solvent to the first mixture may include, without limitation, adding an alcohol or a ketone to the first mixture. Non-limiting examples of solvents may include ethanol, acetone, and chloroform.

The second mixture may be subjected 130 to at least one reaction condition to form the adhesive. In one non-limiting embodiment, the reaction condition may include sonicating the second mixture. Sonication may include, without limitation, sonicating the second mixture for about 20 minutes using 3 minute pulses at 700 watts power. The amount of sonication time and/or power may depend upon the volume of the second mixture subjected to sonication. In another embodiment, the reaction conditions may include grinding up a botanical source of the at least one catechol and a source—including a chemical source, a botanical source, or a processed botanical source—of at least one amine into a paste

The method may also include isolating the adhesive from the second mixture. Non-limiting examples of the isolation operation may include centrifuging the second mixture and retaining the supernatant, filtering the second mixture and retaining the effluent, or a combination of the two.

The adhesive may be composed of multiple subunits comprising structures disclosed by Formulae 1 and 2. In some embodiments, the adhesive may be formed as a network of such subunits. Such a polymer network may include, without limitation, a branch polymer, a star polymer, a comb polymer, a brush polymer, a dendrimer, or combinations thereof. In other embodiments, the adhesive may form a closed or cyclic polymer. In some embodiments, the number of subunits comprising structures disclosed by Formulae 1 and 2 that together form a cyclic polymer may include about 2 to about 23 subunits. Non-limiting examples of cyclic polymers may include about 2 subunits, about 4 subunits, about 8 subunits, about 10 subunits, about 12 subunits, about 16 subunits, about 20 subunits, about 20 subunits, about 23 subunits, or ranges between any two of these values (including endpoints). Structure 2 may be a non-limiting example of a cyclic polymer form of the adhesive. Structure 2 may comprise one component of Formula 1 and one component of Formula 2 in which A is a phenyl group, R₄ and R₅ are H, and R₁ is an allyl group substituted at the phenyl 4 position of the catechol moieties.

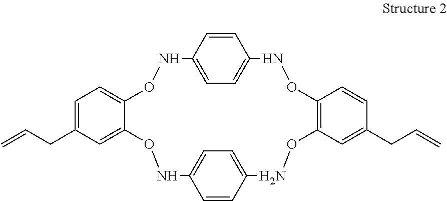 [SMILES: C=CCc1ccc2c(c1)ONc1ccc(cc1)NOc1cc(CC=C)ccc1ONc1ccc(cc1)NO2]

It may be understood that structure 2 is a non-limiting example with respect to any enantiomeric structure of such a cyclic polymeric form of the adhesive.

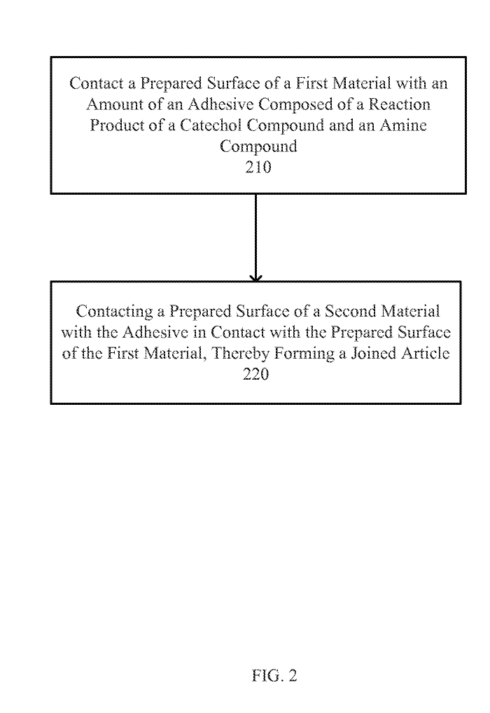

FIG. 2 is a flow chart of a non-limiting method for using an adhesive as produced by the method disclosed in FIG. 1. The method may include preparing a surface of a first material and contacting 210 it with an amount of an adhesive. The adhesive may include a reaction product of a catechol and an amine. A surface may be prepared on a second material, and the prepared surface of the second material may be contacted 220 with the adhesive in contact with the surface of the first material. The resulting article may be termed a joined article. Alternatively, the adhesive may be applied to one surface, and a second surface put in place contacting the adhesive on the first surface, thus creating an adhesive between the two surfaces.

Each of the surface of the first material and the surface of the second material may be prepared independently. Methods for preparing the surface may include, without limitation, cleaning with a cleaning solution, sonicating the surface in a sonication bath, applying a high pressure fluid to the surface, surface roughening, or combinations thereof. Examples of cleaning solution may include, without limitation, water, an alcohol (such as ethanol), and a dilute solution of potassium dichromate in sulfuric acid. Non-limiting examples of fluids that may be used for high-pressure preparation operations may include air, water, or a combination thereof. Non-limiting examples of surface roughening may include sanding and etching.

The adhesive of the joined article may be allowed to cure for some period of time under ambient conditions. In some non-limiting embodiments, the joined article may be placed under pressure (for example in a vice) to stabilize the two materials of the joined article while the adhesive cures. In another non-limiting embodiment, the joined article may be heated to a temperature below a melting temperature of the two materials for a period of time. In some non-limiting embodiments, the joined article may be heated to a temperature of about 50 degrees C. to about 200 degrees C. In some non-limiting examples, the joined article may be heated to a temperature of about 50 degrees C., about 100 degrees C., about 150 degrees C., about 200 degrees C., or ranges between any two of these values (including endpoints). If the two materials have different melting temperatures, the joined article may be heated to the lower melting temperature of the two materials. In some non-limiting examples, the joined article may be heated to a temperature of about 50 degrees C., which may be below the melting temperature of a carbon fiber reinforced polymer. In another non-limiting example, the joined article may be heated to a temperature of about 200 degrees C., which may be below the melting temperature of a ceramic material. In some non-limiting examples, the joined article was heated at 50 degrees C. for about 10 to about 15 minutes. In some non-limiting examples, the joined article was heated at 100 degrees C. for about 8 to about 12 minutes. In some non-limiting examples, the joined article was heated at 150 degrees C. for about 6 to about 10 minutes. In yet another non-limiting example, the joined article was heated at 200 degrees C. for about 2 to about 3 minutes.

### EXAMPLES

### Example 1

### A Method of Making an Adhesive from Botanical Sources

In a blender, about 1 gram of betel leaf (folium Piper betle) and about 3 grams of black henna preparation (folium Lawsonia inermis) were ground into a fine paste for about 10 minutes. To the paste, about 20 ml of ethanol was added, and the mixture was filtered and centrifuged. The supernatant was collected and used as the adhesive.

### Example 2

### A Method of Making an Adhesive from Chemical Supply Sources

5 ml of a 3 molar solution of para-phenylenediamine solution and 1 ml of a 0.5 molar solution of hydroxychavicol (4-allylcatechol) solution were added to 10 ml ethanol. The solution was sonicated for 20 minutes in 3 minute cycles at 700 Watts to yield the adhesive. Sonication may be carried out using a bath sonicator or a probe sonicator.

### Example 3

### Physical Properties of an Adhesive Resulting from a Reaction of a Catechol and an Amine

Properties were determined for an adhesive synthesized from botanical sources as disclosed in Example 1, above. The amount of outgassing of the adhesive under heated conditions was determined by placing about 5.5 g of adhesive in a quartz crucible, and heating the adhesive at about 250 degrees C. in a quartz tube evacuated to a vacuum of about 0.1 kPa pressure. The crucible was weighed after a period of time to determine mass loss due to outgassing. Table 1 presents the results.

TABLE 1

| Time | Weight (g) | Weight (g) | Weight (g) | Percent Weight |
|---|---|---|---|---|
| (hours) | Initial | Final | Change | Loss |
| 1 | 5.448 | 5.428 | −0.02 | 0.37% |
| 2 | 5.428 | 5.412 | −0.016 | 0.29% |
| 3 | 5.412 | 5.32 | −0.092 | 1.7% |
| 4 | 5.32 | 5.32 | 0 | 0% |
| 5 | 5.32 | 5.32 | 0 | 0% |
| 12 | 5.32 | 5.32 | 0 | 0% |

The adhesive did not lose measureable weight after about three hours under the heating and vacuum conditions. While about 2.3% of the initial weight of the sample was lost (percent total mass loss, or % TML) in the first three hours under the heat and vacuum conditions indicated, no further weight loss was observed thereafter. The % TML over time of the botanically-derived adhesive as disclosed in Table 1 may be compared to the results of other adhesives tested according to the ASTM Standard E595-07 protocol disclosed above. As examples, under ASTM Standard E595-07 testing conditions, some epoxy adhesives demonstrated a % TML of about 11.69, some silicone adhesives demonstrated a % TML of about 2.85, and some urethane-based adhesives demonstrated a %TML of about 9.52. It may be appreciated that the botanically-derived adhesive demonstrates a low over-all % TML which stabilized after a short period of time (about 3 hours).

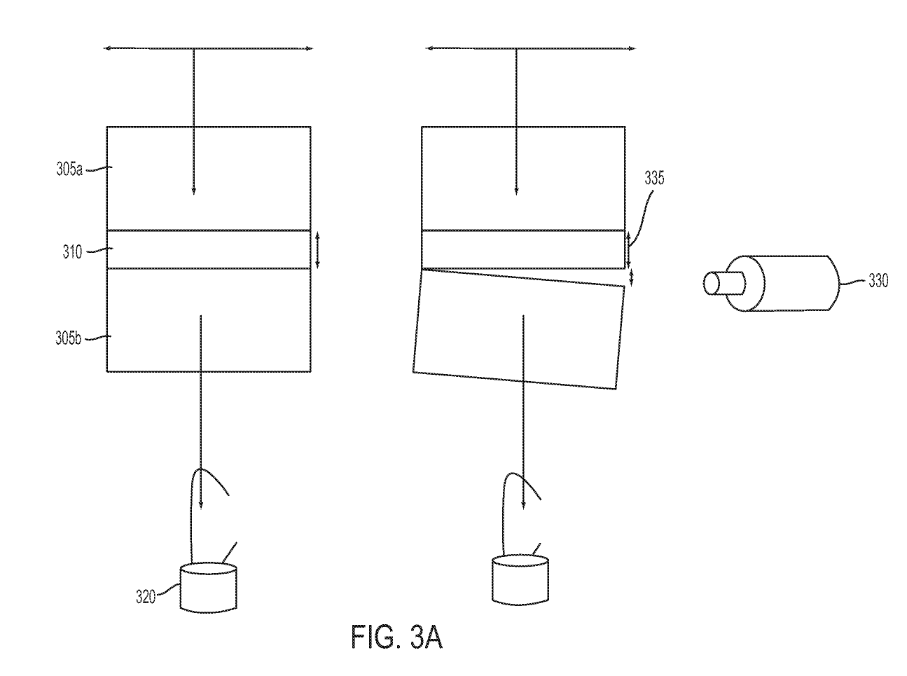

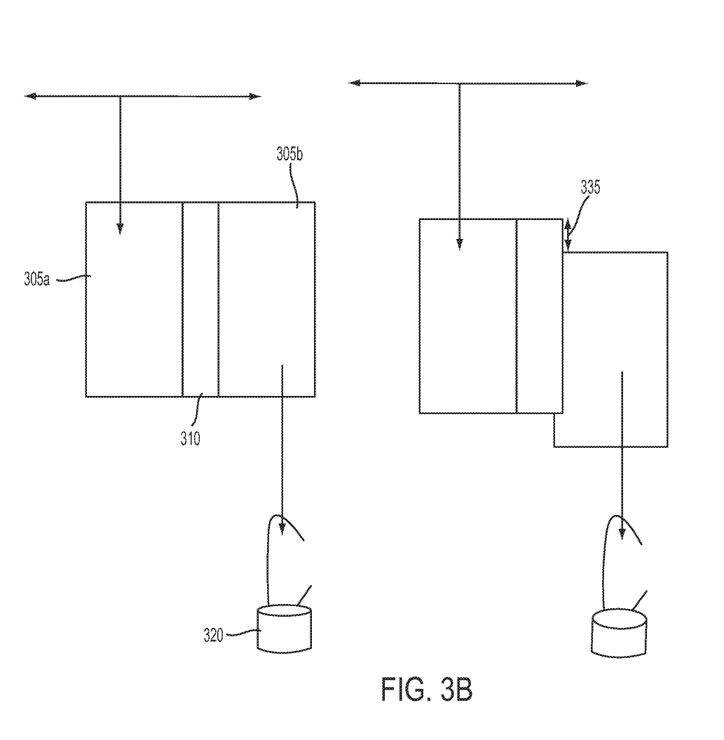

Tensile stress and shear stress for the adhesive were measured under a number of different conditions. Tensile stress was measured with an apparatus depicted in FIG. 3A. The tensile stress test apparatus included joined article composed of a first material 305a and a second material 305b having an amount of cured adhesive 310 between and in contact with their proximate surfaces. The first material 305a was associated with a horizontal stabilizing means and a load 320 was attached to the second material 305b. The load 320 was varied and the vertical deformation 335 of the adhesive was visualized and measured using a digitizing camera 330 as the load increased. Tensile stress was measured as the amount of load 320 able to cause the adhesive seal 310 to break. Tensile strain was measured as the relative change in the vertical deformation 335 of the adhesive seal 310 as a function of load 320.

Shear stress was measured with an apparatus depicted in FIG. 3B. The shear stress test apparatus included joined article composed of a first material 305a and a second material 305b having an amount of the adhesive 310 placed on their proximate surfaces. The first material 305a was associated with a vertical stabilizing means and a load 320 was attached to the second material 305b. The load 320 was varied and the vertical deformation 335 of the adhesive was visualized and measured. Shear stress was measured as the amount of load 320 that was able to cause the adhesive seal 310 to break. Shear strain was measured as the relative change in the vertical deformation 335 of the adhesive seal 310 as a function of load 320.

Table 2 presents data for one set of experiments in which the first material 305a and the second material 305b were both ceramic materials.

TABLE 2

| Load | Tensile Strain |
|---|---|
| (kPa) | (Δ length/unit length) |
| 49.03 | 0 |
| 73.54 | 0 |
| 98.1 | 0 |
| 112.6 | 0 |
| 147.1 | 0 |
| 171.6 | 0 |
| 196.1 | 0 |
| 220.6 | 0 |
| 245.2 | 0.1 |
| 294.2 | 0.2 |
| 343.2 | 0.3 |
| 367.7 | 0.4 |
| 392.2 | 0.5 |
| 416.8 | 0.6 |
| 441.3 | 0.7 |
| 490.3 | 0.8 |
| 514.8 | Break Point |

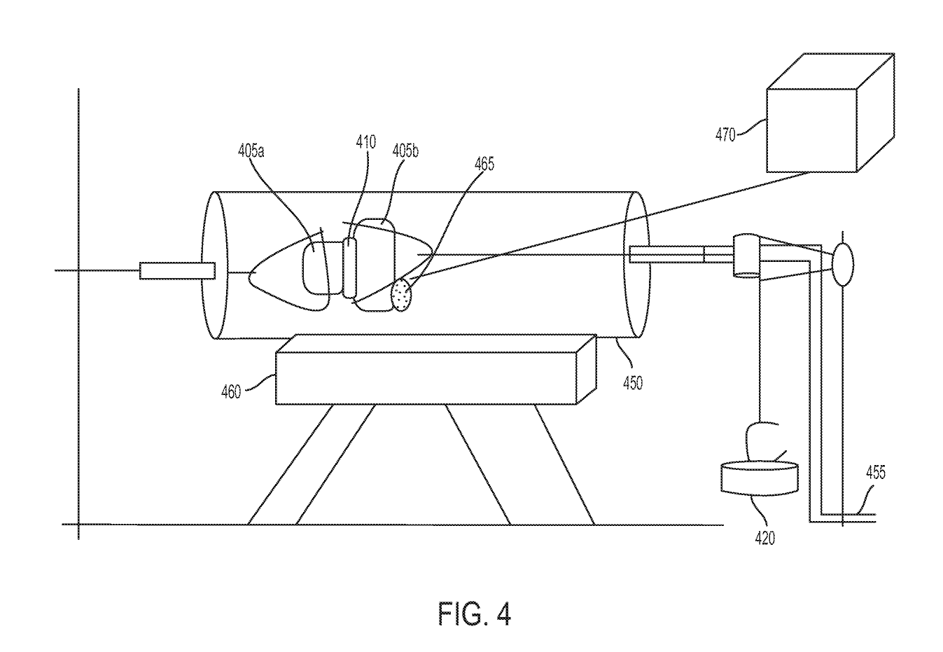

No measureable deformation was observed for loads less than about 220 KPa for this material, and the breakpoint load was at about 515 KPa. Tests were also conducted in which the first material 305a and second material 305b were combinations of: ceramic/ceramic, ceramic/aluminum, stainless steel/stainless steel, carbon fiber reinforced polymer (CFRP)/CFRP, stainless steel/aluminum, ceramic/CFRP, and CFRP/metal. Tensile and shear stress were measured under ambient conditions (32 degrees C. at 42% relative humidity), heated conditions (250 degrees C. at 42% relative humidity), differential temperature conditions (one material at 250 degrees C. the second material at 32 degrees C., at 42% relative humidity) and at heated conditions under vacuum (about 200 degrees C. at a pressure of 0.1 KPa). FIG. 4 illustrates a test apparatus to measure the tensile stress of an adhesive under heat and vacuum conditions. The apparatus includes a sealed quartz tube 450 that can be evacuated through a vacuum line 455. A joined article composed of a first material 405a joined to a second material 405b by means of an adhesive 410 is disposed within the quartz tube 450. A heat source 460 is also provided to heat the joined article, and a temperature sensor 465 associated with the joined article provides a temperature signal to a temperature measuring device 470. Stress is provided by means of a load 420 attached to the second material 405b.

In both tensile and shear stress studies, all of the joined articles composed of the pairs of materials disclosed above were able to withstand a force of 14.7 N without deformation of the adhesive between the two materials under ambient conditions (temperature and pressure). Under ambient pressure in which one material was held at about 250 degrees C. and the other material was held at about ambient temperature, all the joined articles composed of the pairs of materials disclosed above were able to withstand a force of 9.8 N in both tensile stress and shear stress studies. In both shear stress and tensile stress studies at temperatures of about 200 degrees C. to about 214 degrees C. and at a vacuum of about 10⁻⁴ kPa, all the joined articles composed of the pairs of materials disclosed above were able to withstand a force of about 4.9 N without showing deformation of the adhesive material between the materials.

### Example 4

### A Method of Using an Adhesive

The surfaces of a first material and a second material were abraded by the use of sand paper, and subsequently cleaned by sonication in ethanol. Two hundred microliters of adhesive derived from botanical sources, as disclosed above in Example 1, was deposited over a 2 cm×2 cm area on the roughened surfaces using a syringe. The first material and the second material were contacted with the adhesive between the two materials to form a joined article. The joined article was then clamped together and the adhesive was allowed to cure. The joined article may be heated or allowed to cure at ambient temperature. Joined articles made of ceramic substrates were heated to about 200 degrees C. for about 10 minutes. Joined articles made of carbon fiber reinforced polymer (CFRP) were heated to about 50 degrees C. for about 2 hours. Curing times appeared to be dependent on the cure temperature. Thus, a cure time of about 6 hours was observed for joined articles maintained at about ambient temperature. A cure time of about 1 hour was observed for joined articles maintained at about 100 degrees C. A cure time of about 15 minutes to about 20 minutes was observed for joined articles maintained at about 150 degrees C.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated in this disclosure, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used in this disclosure is for the purpose of describing particular embodiments only, and is not intended to be limiting.

With respect to the use of substantially any plural and/or singular terms in this disclosure, those having skill in the art can translate from the plural to the singular and/or from the singular to the plural as is appropriate to the context and/or application. The various singular/plural permutations may be expressly set forth in this disclosure for sake of clarity.

It will be understood by those within the art that, in general, terms used in this disclosure, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed in this disclosure also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed in this disclosure can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, it will be appreciated that various embodiments of the present disclosure have been described for purposes of illustration, and that various modifications may be made without departing from the scope and spirit of the present disclosure. Accordingly, the various embodiments disclosed are not intended to be limiting, with the true scope and spirit being indicated by the following claims.

What is claimed is:

1. A method for making an adhesive, the method comprising:
contacting at least one catechol with at least one amine to form a first mixture;
adding at least one solvent to the first mixture to form a second mixture; and
subjecting the second mixture to at least one reaction condition thereby forming the adhesive.

2. The method of claim 1, further comprising isolating the adhesive from the second mixture.

3. The method of claim 2, wherein isolating the adhesive comprises one or more of centrifuging or filtering the second mixture.

4. The method of claim 1, wherein contacting at least one catechol comprises contacting at least one substituted catechol.

5. The method of claim 1, wherein contacting at least one catechol comprises contacting one or more of a 3-substituted catechol, a 4-substituted catechol, and a 3,4-disubstituted catechol.

6. The method of claim 1, wherein contacting at least one catechol comprises contacting one or more of a 4-alkyl substituted catechol, a 4-alkene substituted catechol, and a 4-alkyne substituted catechol

7. The method of claim 1, wherein contacting at least one catechol comprises contacting at least one catechol having at least one substitution group comprising a primary carbon backbone having from 1 to about 25 carbons.

8. The method of claim 1, wherein contacting at least one catechol comprises contacting at least one catechol having at least one substitution group comprising a primary carbon backbone having one or more independently chosen carbon side-chains, the one or more independently chosen carbon side-chains having from 1 to about 5 carbons.

9. The method of claim 1, wherein contacting at least one catechol comprises contacting one or more of a 4-methyl catechol, a 4-ethyl catechol, a 4-propyl catechol, a 4-butyl catechol, a 4-(ethenyl)catechol, a 4-(2-propen-1-yl)catechol, a 4-(3-buten-1-yl)catechol, a 4-(ethynyl)catechol, a 4-(2-propyn-1-yl)catechol, and a 4-(3-butyn-1-yl)catechol.

10. The method of claim 1, wherein contacting at least one catechol comprises contacting a 4-(2-propen-1-yl)catechol.

11. The method of claim 1, wherein contacting at least one catechol with at least one amine comprises contacting the at least one catechol with one or more of a tertiary amine, and a diamine.

12. The method of claim 1, wherein contacting at least one catechol with at least one amine comprises contacting the at least one catechol with nitrilotriacetic acid.

13. The method of claim 1, wherein contacting at least one catechol with at least one amine comprises contacting the at least one catechol with one or more of an alkylene diamine, an alkenylene diamine, an alkynylene diamine, and an aryl diamine.

14. The method of claim 1, wherein contacting at least one catechol with at least one amine comprises contacting the at least one catechol with one or more of methylene diamine, ethylene diamine, ethylene diamine tetraacetic acid, propylene diamine, butylene diamine, 1,2 phenylene diamine, 1,3 phenylene diamine, 1,4 phenylene diamine, and 1,1′-diphenyl diamine.

15. The method of claim 1, wherein contacting at least one catechol with at least one amine comprises contacting the at least one catechol with 1,4 phenylene diamine.

16. The method of claim 1, wherein contacting at least one catechol with at least one amine to form a first mixture comprises contacting at least one catechol with at least one amine to form a first mixture having a molar ratio of the at least one catechol to the at least one amine of about 2:1 to about 5:1.

17. The method of claim 1, wherein adding at least one solvent comprises adding one or more of an alcohol and a ketone.

18. The method of claim 1, wherein adding at least one solvent comprises adding one or more of ethanol, acetone, and chloroform.

19. The method of claim 1, wherein subjecting the second mixture to at least one reaction condition comprises subjecting the second mixture to one or more of filtering, centrifuging, and sonicating.

20. An adhesive material comprising:
a compound of Formula 1: 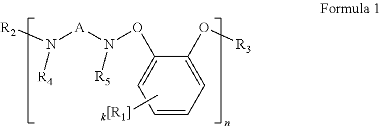
wherein:
n is an integer of 2 to about 25;
each A is independently selected from an alkyl, an alkenyl, an alkynyl, or an aryl moiety;
each R₁ is independently selected from an alkyl, an alkenyl, or an alkynyl moiety;
each k is a number of groups R₁ and is an integer of 0 to 4;
R₂ and R₃ are hydrogen or joined together when n is greater than or equal to 2;
each R₄ and each R₅ are independently selected from a hydrogen or a compound of Formula 2; 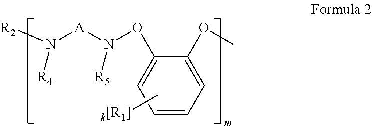
wherein m is an integer of 2 to about 25.

21. The adhesive material of claim 20, wherein R₂ and R₃ are joined together when n is greater than or equal to 2 and less than 23, thereby forming one or more cyclic polymers.

22. An adhesive material comprising:
a reaction product of one or more catechol compounds and one or more amine compounds.

23. The adhesive material of claim 22, wherein the one or more catechol compounds are a 3-substituted catechol, a 4-substituted catechol, or a 3,4-disubstituted catechol.

24. The adhesive material of claim 22, wherein the one or more catechol compounds are a 4-alkyl substituted catechol, a 4-alkene substituted catechol, a 4-alkyne substituted catechol, or any combination thereof

25. The adhesive material of claim 22, wherein the one or more catechol compounds are 4-methyl catechol, 4-ethyl catechol, 4-propyl catechol, 4-butyl catechol, 4-(ethenyl)catechol, 4-(2-propen-1-yl)catechol, 4-(3-buten-1-yl)catechol, 4-(ethynyl)catechol, 4-(2-propyn-1-yl)catechol, 4-(3-butyn-1-yl)catechol, or any combination thereof.

26. The adhesive material of claim 22, wherein the one or more catechol compounds are 4-(2-propen-1-yl)catechol.

27. The adhesive material of claim 22, wherein the one or more amine compounds are an alkylene diamine, an alkenylene diamine, an alkynylene diamine, an aryl diamine, or any combination thereof.

28. The adhesive material of claim 22, wherein the one or more amine compounds are methylene diamine, ethylene diamine, ethylene diamine tetraacetic acid, propylene diamine, butylene diamine, 1,2 phenylene diamine, 1,3 phenylene diamine, 1,4 phenylene diamine, 1,1′-diphenyl diamine, or any combination thereof.

29. The adhesive material of claim 22, wherein the one or more amine compounds is 1,4 phenylene diamine.
